(19) United States
(12) Patent Application Publication
(10) Pub. No.: US 2018/0127216 A1
(43) Pub. Date: May 10, 2018

(54) DEFLECTOR FOR A BROADCAST SPREADER

(71) Applicant: Richard George Hazelton, Cudal (AU)

(72) Inventor: Richard George Hazelton, Cudal (AU)

(21) Appl. No.: 15/862,399

(22) Filed: Jan. 4, 2018

Related U.S. Application Data
(62) Division of application No. 14/832,354, filed on Aug. 21, 2015.

(30) Foreign Application Priority Data
Oct. 28, 2014 (AU) 2014904300

(51) Int. Cl. B65G 31/04; E01C 19/20; A01C 17/00

(52) U.S. Cl. CPC B65G 31/04; A01C 17/008; A01C 17/006; E01C 19/20

(57) ABSTRACT

The invention comprises a deflector assembly for use with a spreading disc rotatable around a first axis, the deflector assembly comprising an array of deflector members concentrically disposed relative to the first axis, wherein a stream of particulate material discharged onto the deflector assembly is deflected onto a portion of the spreading disc.

### CROSS REFERENCE TO RELATED APPLICATIONS

This application is a divisional and claims the priority to U.S. application Ser. No. 14/832,354, filed Aug. 21, 2015, which claims priority to Australian Application No. 2014904300, filed Oct. 28, 2014, the disclosures of which are incorporated by reference in their entireties.

### FIELD OF THE INVENTION

This invention relates to devices for dispersing particulate material. In particular, the invention relates to a broadcast spreader and components thereof used for the distribution of fertiliser, pesticides, seeds and other finely divided material to soil or vegetation.

### DESCRIPTION OF THE RELATED ART

Broadcast spreaders are known for dispersing particulate materials. The basic function of a spreader is to drop particulate material onto a rotating spreading disc that throws the particles out from the broadcast spreader. Factors such as the forward speed of the broadcast spreader, the shape and placement of the flinger blades on the spreading disc, the concavity (if any) of the spreading disc, the rate of spin of the rotating spreading disc and the characteristics of the particulate material (such as moisture, density and size) can influence the ultimate distribution rate and pattern.

On spreaders for small areas, these factors are usually fixed at a compromise value intended for optimum results for particulate material with a wide variety of sizes and densities. On larger commercial and agricultural spreaders, one or more of the controlling factors may be adjusted to optimize pattern performance as a function of the physical characteristics of the particulate material.

Typical means of pattern adjustment include changing the angle of the flinger blades, controlling the spin rate of the spreading disc and moving the drop point radially by linear movement of a primary deflector. One such adjustment means is shown in U.S. Pat. No. 4,367,848 to Ehmke et al. which discloses the use of axially adjustable vanes to achieve even distribution of a dry material. However, most such adjustment means are burdensome to use and not readily adjustable for the physical characteristics of various particulate material.

Accordingly, it can be seen that a need exists for a broadcast spreader designed and developed to overcome, or at least substantially ameliorate, the disadvantages and shortcomings of the prior art.

### SUMMARY OF THE INVENTION

According to a first aspect, the invention resides broadly in a deflector assembly for use with a spreading disc rotatable around a first axis comprising an array of deflector members concentrically disposed relative to the first axis; wherein a stream of particulate material discharged onto the deflector assembly is deflected onto a portion of the spreading disc.

Preferably each deflector member has an upper surface which extends axially and radially, wherein the array of deflector members is substantially frusto-conical in shape.

Preferably each deflector member has a bottom surface which substantially abuts the upper surface of the spreading disc.

In the preferred form of the invention the array of deflector members includes a main deflector member and at least one extension member. Preferably, the or each at least one extension member is removable from the array of deflector members. It is preferred that the portion upon which the particulate material is deflected is altered by varying the number of deflector members in the array.

In one preferred embodiment the array of deflector members is formed by positioning one deflector member alongside of another. In an alternative preferred embodiment, the array of deflector members is formed by nesting one deflector member on top of another.

In another aspect, the invention resides broadly in a discharge deflector for a discharge outlet of a broadcast spreader comprising a primary deflector positionable adjacent the discharge outlet for directing a stream of particulate material downwards towards a spreading disc; and a side deflector positionable adjacent a side region of the discharge outlet for channeling the stream of particulate material towards the spreading disc.

Preferably the primary deflector is disposed below the discharge outlet, and is movable in relation to the discharge outlet.

In one preferred embodiment the discharge deflector further comprises a central diverter which is integrally formed with the primary deflector.

### BRIEF DESCRIPTION OF THE DRAWINGS

It will be appreciated by those of relevant skill that the disclosed embodiments are merely exemplary of the invention, and that the invention may be embodied in various and alternative forms. The invention will now be described in a non-limiting manner with reference to the accompanying drawings which illustrate a preferred embodiment of the invention, wherein:

FIG. 1 is a perspective view of a deflector assembly mounted upon a spreading disc;

FIG. 2 is a cross sectional view through a main deflector member;

FIG. 3 is a cross sectional view through a first extension member;

FIG. 4 is a cross sectional view through a second extension member;

FIG. 5 is a side view of a deflector assembly comprising a main deflector member and two extension members;

FIG. 6 is a cross sectional view of the deflector assembly of FIG. 5;

FIG. 7 is a perspective view of the deflector assembly of FIG. 5;

FIG. 8 is a cross sectional view through a first alternative embodiment of the deflector assembly;

FIG. 9A is a perspective view of a 4-way deflector assembly according to a second alternative embodiment of the present invention;

FIG. 9B is an alternative perspective view of the 4-way deflector assembly;

FIG. 10A is a front side view of the 4-way deflector assembly;

FIG. 10B is a right side view of the 4-way deflector assembly;

FIG. 10C is a rear side view of the 4-way deflector assembly;

FIG. 10D is a left side view of 4-way deflector assembly;

FIG. 11 is a plan view of the 4-way deflector assembly;

FIG. 12 is a schematic depicting the preferred dimensions of the 4-way deflector assembly;

FIG. 13 is a schematic depicting the preferred dimensions of a 3-way deflector assembly;

FIG. 14A is a perspective view of a 3-way deflector assembly according to an alternative embodiment of the present invention;

FIG. 14B alternative perspective view of the 3-way deflector assembly;

FIG. 15 is a perspective view of a central diverter;

FIG. 16A is a schematic depicting the preferred dimensions of the central diverter of FIG. 15;

FIG. 16B is a further schematic depicting the preferred dimensions of the central diverter;

FIG. 17 is an alternative embodiment of the deflector assembly;

FIG. 18 is a left side rear view of a broadcast spreader including a spreading disc with a deflector assembly when comprised of two deflector members;

FIG. 19 is a left side rear view of a broadcast spreader including a primary deflector and a side deflector;

FIG. 20 is a right side rear view of a broadcast spreader including a primary deflector and a central diverter positioned above a spreading disc;

FIG. 21 is a front view of the primary deflector;

FIG. 22 is a side view of the primary deflector;

FIG. 23 is a right side rear view of the primary deflector; and

FIG. 24 shows the deflector assembly of FIG. 17 with a lower deflector sub-assembly in place.

It will be appreciated by those of relevant skill that the figures are not necessarily to scale, with some features exaggerated or minimised to show details of particular components. Like numerals in the drawings refer to like parts.

### DETAILED DESCRIPTION OF PREFERRED EMBODIMENTS

In the following discussion and in the claims that follow, the term “particulate material” denotes a bulk of particles in their broadest meaning including powders, granular material, seeds, pellets and the like, which can include, for example, fertiliser, pesticides, chemicals, insecticides, weed killers, herbicides, ice salt, calcium chloride and like materials.

In the following discussion and in the claims that follow, the term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment”, “alternative embodiment” and the like mean “one or more (but not all) embodiments of the disclosed invention(s)”, unless expressly specified otherwise. A reference to “another embodiment” in describing an embodiment does not imply that the referenced embodiment is mutually exclusive with another embodiment (e.g., an embodiment described before the referenced embodiment), unless expressly specified otherwise.

Numerous references to a particular embodiment does not indicate a disclaimer or disavowal of additional, different embodiments, and similarly references to the description of embodiments which all include a particular feature does not indicate a disclaimer or disavowal of embodiments which do not include that particular feature. A clear disclaimer or disavowal in the present application shall be prefaced by the phrase “does not include” or by the phrase “cannot perform”.

The terms “including”, “comprising” and variations thereof mean “including but not limited to”, unless expressly specified otherwise. The terms “a”, “an” and “the” mean “one or more”, unless expressly specified otherwise. The term “plurality” means “two or more”, unless expressly specified otherwise.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device, article or other product is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The preambles of the claims that follow recite purposes, benefits and possible uses of the claimed invention only and do not limit the claimed invention.

The present disclosure is not a literal description of all embodiments of the invention(s). Also, the present disclosure is not a listing of features of the invention(s) which must be present in all embodiments.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

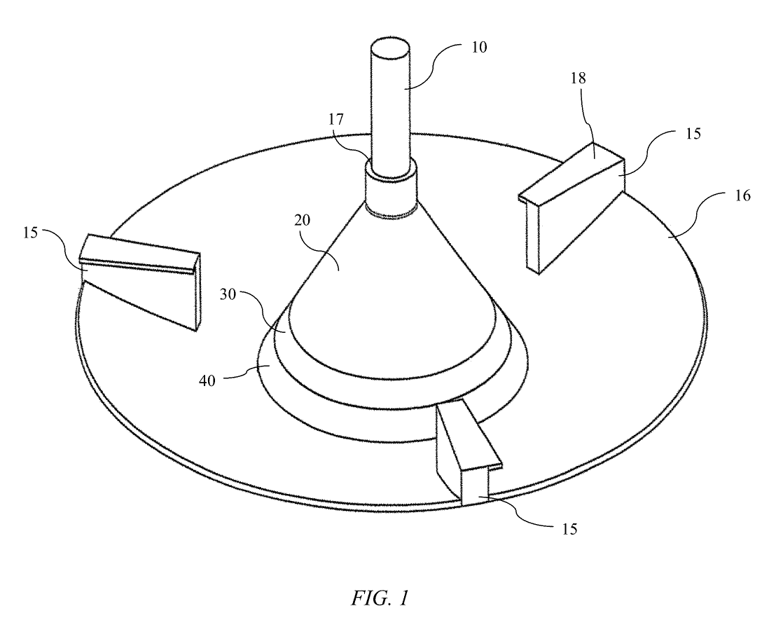

Turning now to FIG. 1, the deflector assembly is made up of main deflector member 20, a first extension member 30 and a second extension member 40, arranged in a so-called concentric ring configuration. The bottom edge of each deflector member substantially abuts the upper surface of the spreading disc 16, which may be flat, convex or concave. The main deflector member 20 has a bore 17 designed to allow the main deflector member to fit over the main drive shaft 10 of the spreading disc 16.

The spreading disc 16 is a unitary moulded or cast member, preferably formed from a strong but lightweight plastic material such as polyurethane that is durable and impact resistant, although it may also be formed from other mouldable or castable materials, including fibreglass, metals and metal alloys, ceramics, carbon fibre materials, or other suitable materials. The spreading disc has a perpendicular axis of rotation through the centre thereof, which axis of rotation may hereafter be referred to as the spreading disc rotation axis, or more simply, the first axis. The spreading disc may be powered in any suitable manner. Suitable power systems may be electric, hydraulic, pneumatic and/or internal combustion. Additionally, power may be derived from other sources. For example, rotational motivation may be diverted from a power take off (PTO) or from the rotation of the wheels of the broadcast spreader as it is towed.

Spreading disc 16 includes a plurality of flinger blades 15, preferably three in number, which extend upwardly from the top surface of the disc and radially from near the outer periphery of the disc towards the centre thereof. Preferably, the flinger blades 15 are evenly spaced, and have a cross section or shape to assist the spreading disc 16 in engaging and dispersing the particulate material. In one embodiment, finger blade 15 may comprise a radially extending member which has a substantially rectangular cross-section. Each finger blade may have an upper extension portion 18 which extends perpendicular to the radial axis. In an alternative embodiment, the finger blade 15 comprises an arcuate member which curves in both the radial and vertical axis.

Flinger blades 15 may be secured to the spreading disc 16 in any suitable manner. For example, the flinger blades may be welded, glued, bolted, snapped, slotted, pinned, wedged, keyed or otherwise secured to the disc. In certain embodiments, the spreading disc 16 and flinger blades 15 may be formed in an integral unit (i.e. moulded or machined from a single piece of stock).

As noted previously, particle distribution is influenced by where the particulate material drops onto the spreading disc. Particles that tend to stay on the spreading disc longer should be dropped onto it closer to the outer periphery of the spreading disc, offsetting the particles' slow exit from the spreading disc. Conversely, materials that tend to leave the spreading disc quickly can be dropped onto it closer to the centre of the spreading disc, forcing them to travel further to leave the spreading disc.

For example, when a dense fertiliser particle such as potassium chloride is dropped toward the outside of the spreader, it typically causes a decrease in the width of the distribution pattern because the particles leave the spreading disc sooner. To compensate for this, a shift of the drop area toward the center of the spreading disc achieves a wider and more uniform distribution pattern. A correction for a less dense particulate material, such as urea, can be achieved in a similar fashion by shifting the drop area toward the outer edge of the spreading disc.

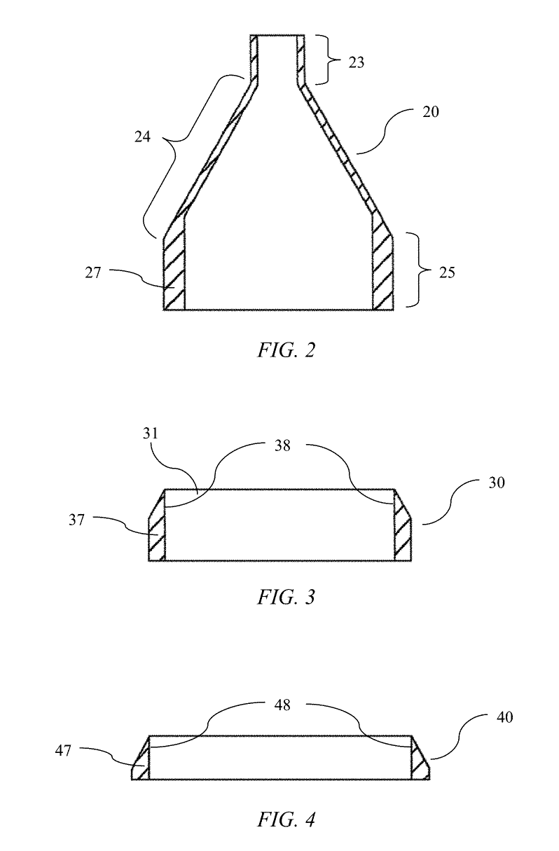

Main deflector member 20 is more clearly seen in FIG. 2. The main deflector 20 includes a cylindrical upper portion 23, a frusto-conical middle portion 24 and a cylindrical lower portion 25. The main deflector 20 is circular in cross-section and is concentric with the axis of rotation of the spreading disc. Preferably, to provide additional strength and durability in the area where the extension members abut, cylindrical lower portion 25 has an increased wall thickness 27.

Each deflector member is a unitary moulded or cast member, preferably made of metal such as various grades of hot-rolled steel, various grades of cold-rolled steel, or from stainless steel, titanium, aluminium and the like. The deflector members could also be made of any other suitably rigid material such as plastics (e.g. nylon, polyurethane etc.), composites (e.g. fiberglass and/or carbon fibre construction), ceramics, or other similar materials. Factors involved in choosing a construction material include durability, tensile strength, hardness and cost.

As seen in FIG. 3, a first extension member 30 comprises a bore which allows the extension member to slip over the main deflector member. Preferably, the inner surface 38 of wall 37 comprises a non-slip surface such that first extension member 30 may securely abut the main deflector member when in use. Surface 38 may be corrugated, irregular, grooved or coated with a high-friction material to provide the required non-slip properties. Second extension member 40 shown in FIG. 4 is similarly configured, and comprises a non-slip surface 48 such that extension member 40 may securely abut the first extension member when in use.

Preferably, the deflector assembly may be adjusted to occupy from approximately 15% to 45% of the diameter of the spreader disc with which it cooperates. As will be appreciated, the lowermost extension member is the widest member of the deflector assembly, and for a standard 600 mm diameter spreader disc, will have a maximum outside diameter of approximately 240 mm to 270 mm.

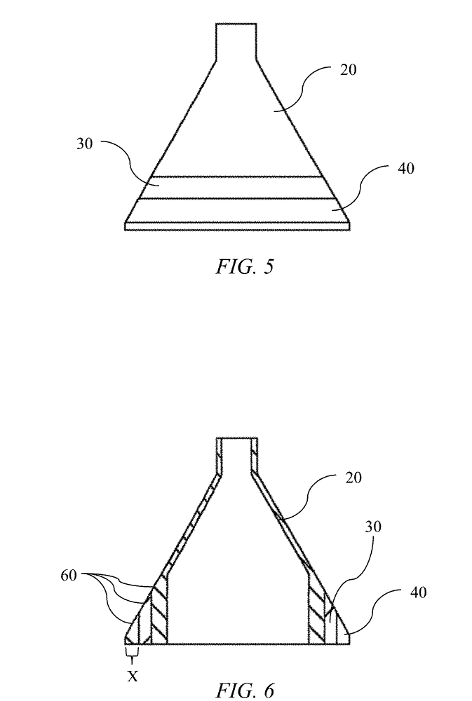

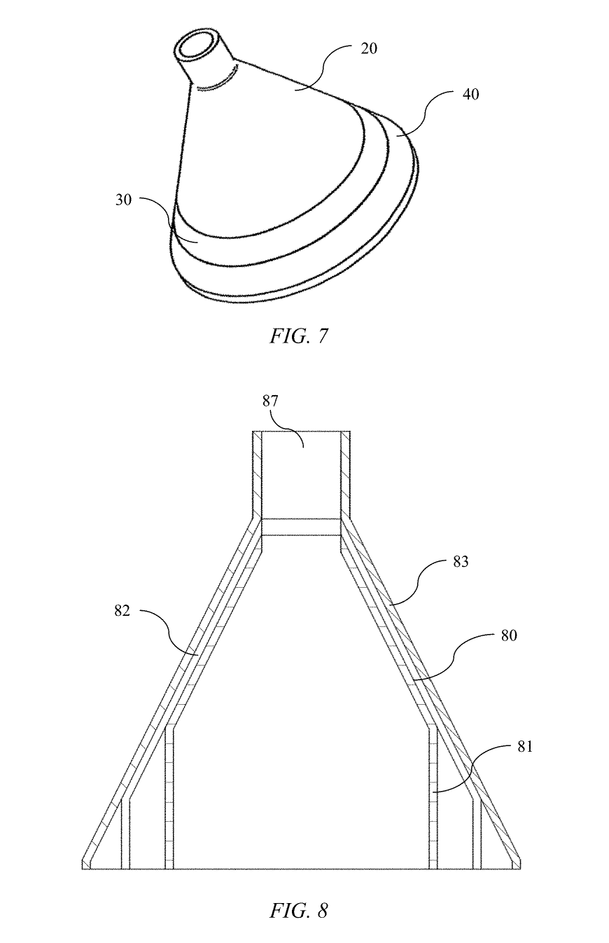

FIG. 5 is a side view of one embodiment of the deflector assembly, and comprises a main deflector member 20 and two extension members 30 and 40. Such an arrangement allows four adjustment settings, ranging from no deflector members upon the spreading disc through to all three deflector members upon the spreading disc. Thus, a stream of particulate material discharged onto the deflector assembly may be dropped or deflected onto four different portions of the spreading disc. Of course, as the person skilled in the art would readily appreciate, the number of possible adjustment settings may be increased or decreased by varying the number of deflector elements from which the deflector array is formed.

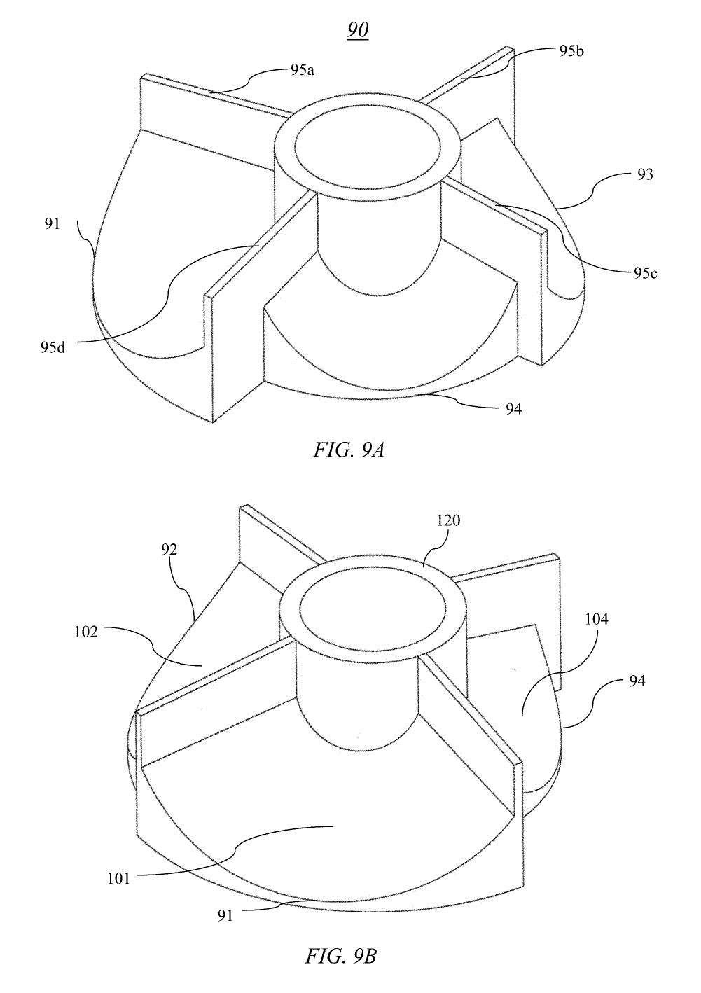

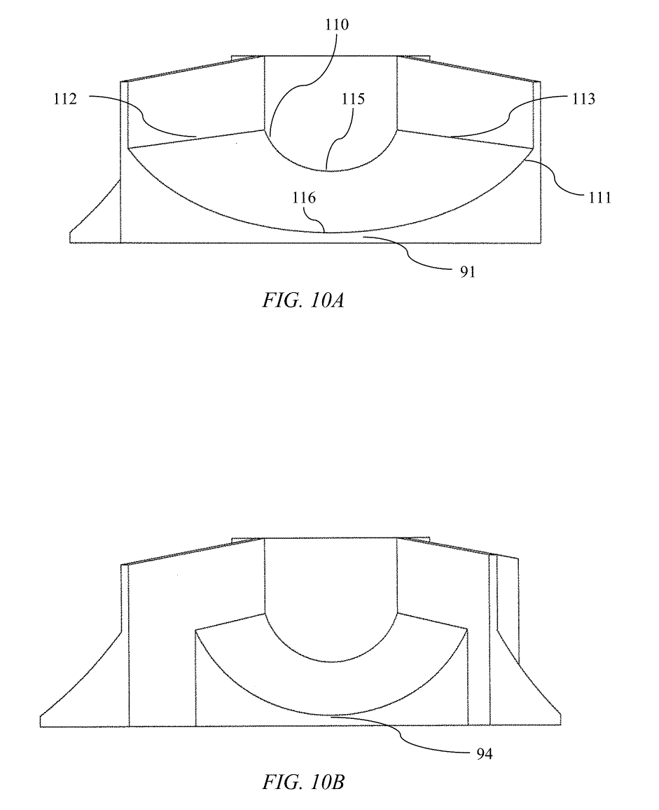

FIGS. 6 and 7 are a cross sectional and perspective view, respectively, of the deflector assembly of FIG. 5. Preferably, the annular width ‘X’ of each extension member is equal. Each deflector member has an upper surface 60 which extends both axially and radially, such that the array of deflector members is substantially frusto-conical in shape.

In an alternative embodiment, the array of deflector members may be adjusted by nesting or stacking a deflector member upon another as shown in FIG. 8. In this example, the array comprises main deflector 81 located at the bottom of the nest or stack, first extension member 82 and second extension member 83. Preferably, the inner surface of the extension members is shaped so as to securely abut the outer surface of the lower deflector member upon which it is nested. Each deflector member has a bore 87 designed to allow the deflector member to fit over the main drive shaft of the spreading disc. Preferably, the inner surface of an upper deflector member abuts an outer surface of a lower deflector member. In this example, the inner surface 80 of deflector member 82 securely abuts the upper surface of deflector member 81.

In a second alternative embodiment, the deflector assembly 90 may comprise a plurality of deflector members forming a circular spiral arrangement in which each deflector member has a discrete radius, as shown in FIGS. 9A to 11. Deflector assembly 90 is concentric with its axis of rotation and is preferably for use with broadcast spreaders in which the drive shaft for the spreader disc is enclosed within a protective housing. The deflector assembly 90 may be formed from any suitably rigid material such as plastics, rubber, metal, composites or the like, and is secured to the drive shaft housing by any suitable means such as a clamp.

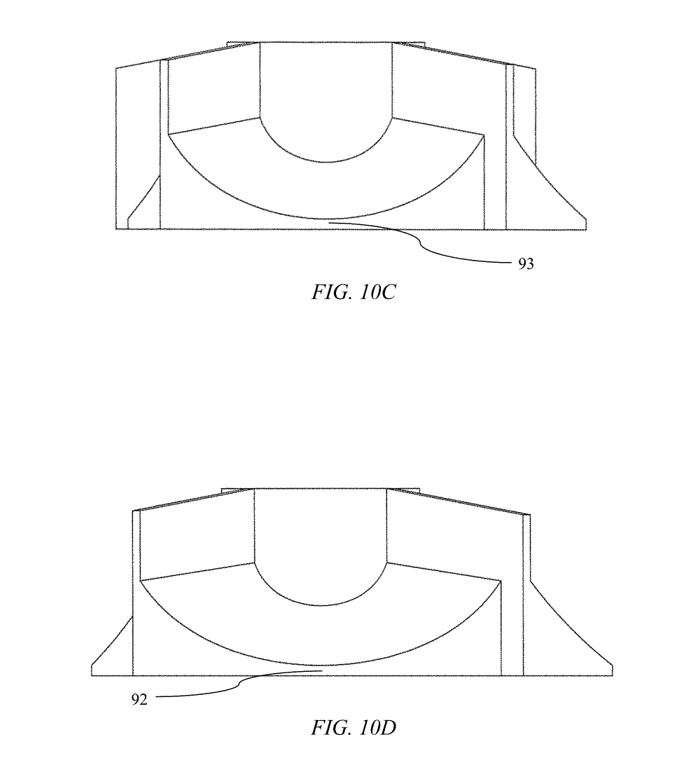

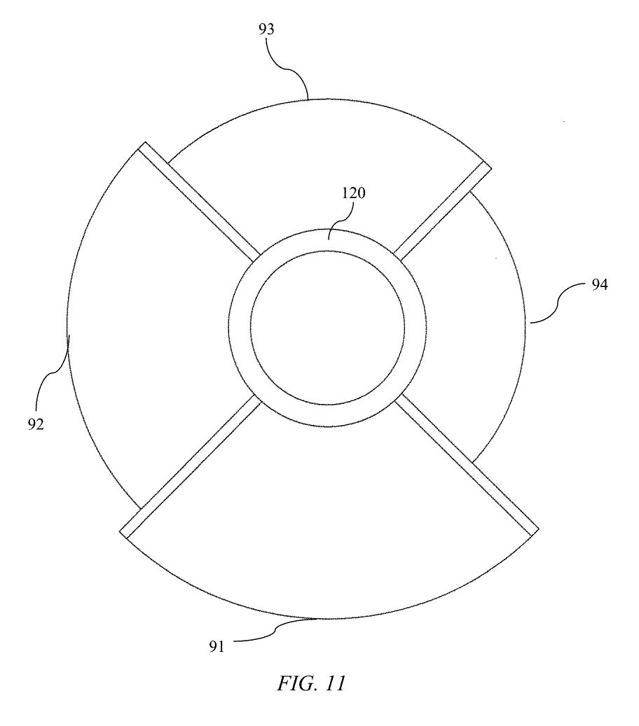

Preferably, the deflector assembly 90 comprises four deflector members 91, 92, 93 and 94 located between fins 95a to 95d which extend radially from central bore portion 120, with each deflector member forming a quadrant of the deflector assembly. It will be seen that the top surface 101, 102, 103 and 104 of each deflector member is concave. As exemplified in FIG. 10A, the centre point 115 of inner edge 110 and the centre point 116 of outer edge 111 of each deflector member are lower than radial edges 112 and 113 at the points that the inner and outer edges meet the fins. Preferably, centre point 115 is approximately 10% to 55%, and preferably between 30% and 35%, below the point at which the radial edges 112 and 113 meet the central bore portion, while centre point 116 is approximately 75% to 95%, and preferably between 83% and 87%, below the point at which the radial edges 112 and 113 meet the central bore portion.

Preferably, radial edges 112 and 113 slope downwards at an angle of between 0° to 30°, and preferably 10°, towards the outer periphery of the spreader disc. The slope of the top surface from centre point 115 to centre point 116 is approximately 15° to 35°, and preferably approximately 28°, with respect to the base of the deflector assembly. The concave design has been found to aid the accurate deflection of a stream of particulate material onto a desired portion of the spreader disc. By rotating the 4-way deflector assembly 90° with respect to the drive shaft housing, it is possible to select the next quadrant of the deflector assembly for use, with the largest radius deflector suitable for materials such as wet lime and the smallest radius deflector suitable for materials such as granular fertilisers.

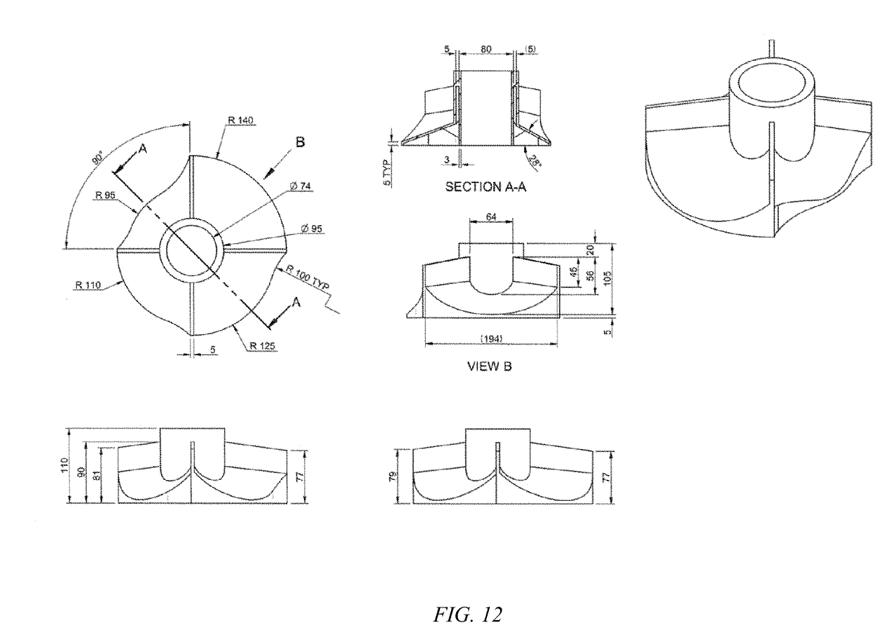

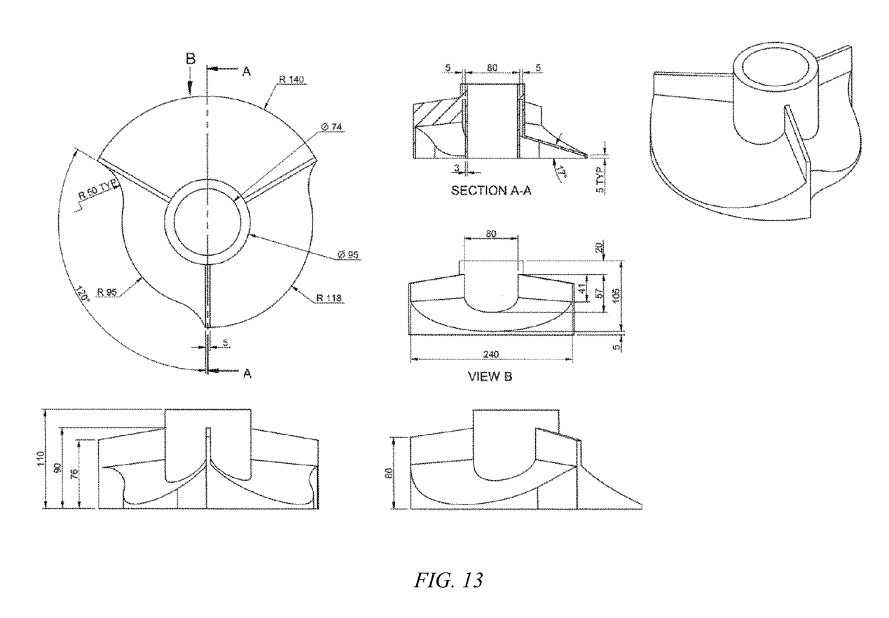

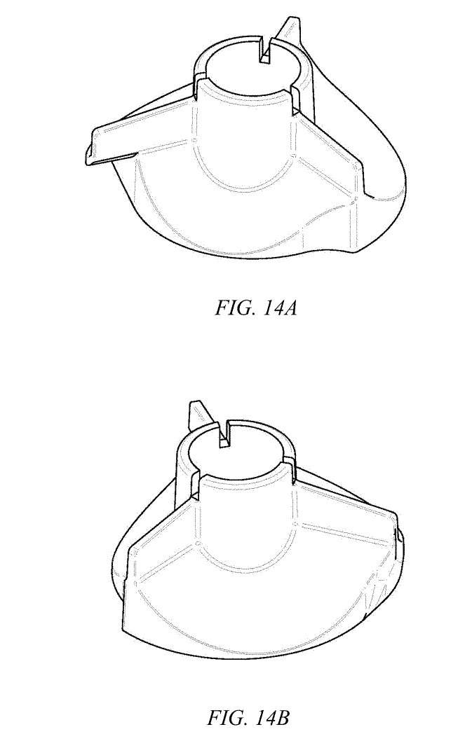

FIG. 12 depicts the preferred dimensions (in millimeters and degrees) of a 4-way deflector assembly. As the person skilled in the art would appreciate, the number of possible adjustment settings may be increased or decreased by varying the number of deflector members from which the deflector assembly is formed. The preferred dimensions of a 3-way deflector assembly are shown in FIG. 13. Similar to the 4-way deflector described previously, the 3-way deflector assembly comprises three deflector members located between three fins which extend radially from a central bore portion, with each deflector member forming approximately a 120o section of the deflector assembly. In a preferred embodiment, the widest section of the deflector assembly has an outer radius between 120 mm and 160 mm, and preferably 140 mm, the next widest section has an outer radius between 138 mm and 98 mm, and preferably 118 mm, and the narrowest section has an outer radius between 115 mm and 75 mm, and preferably 95 mm. It will be seen that the top surface of each 120° section of the deflector member is concave. As exemplified in FIG. 13, the centre point of the inner edge and the centre point of the outer edge of each deflector member are lower than the radial edges at the points that the inner and outer edges meet the fins. The concave design has been found to aid the accurate deflection of a stream of particulate material onto a desired portion of the spreader disc. By rotating the 3-way deflector assembly 120o with respect to the drive shaft housing, it is possible to select the next section of the deflector assembly for use, with the largest radius deflector suitable for materials such as wet lime and the smallest radius deflector suitable for materials such as granular fertilisers. Perspective views of one embodiment of the 3-way deflector are shown in FIGS. 14A and 14B.

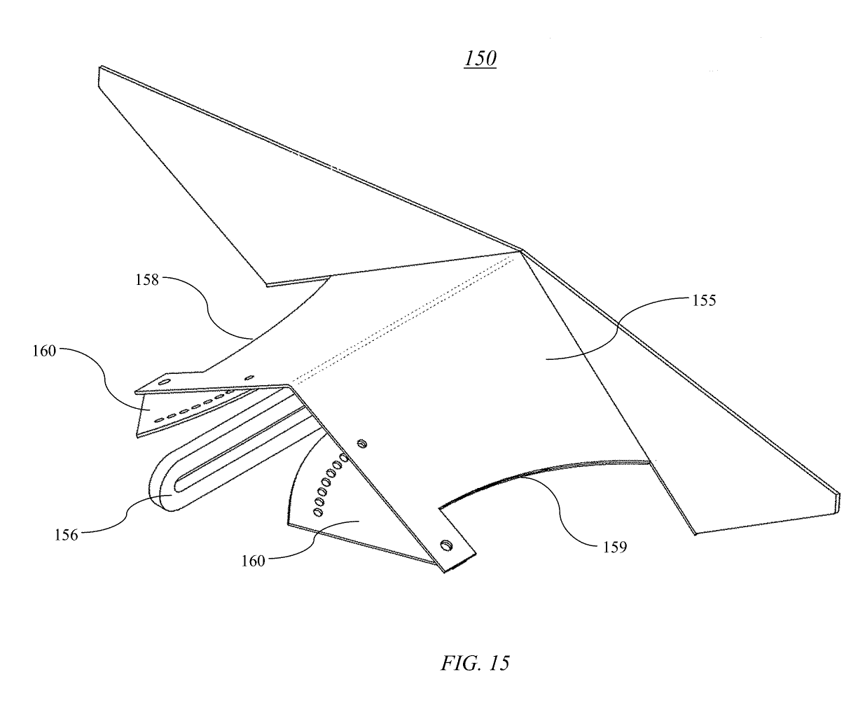

Turning to FIG. 15, the broadcast spreader may also include a discharge deflector mounted near the discharge outlet to assist with directing the stream of particulate material towards the spreading disc. The discharge deflector is preferably formed from polyurethane, though other materials such as metals and composites are suitable. The discharge deflector includes a central diverter 150 mounted near the discharge outlet for directing the stream of particulate material towards a predetermined position on the spreading disc. Central diverter 150 is positioned at the centre of the discharge outlet of the broadcast spreader and opposite a side deflector so as to form a v-shaped channel which streams particulate material towards the spreading disc. The central diverter includes an upper surface 155 which, in the case of a typical bulk material spreader comprising two spreading discs, forms an inverted V-shape in cross-section.

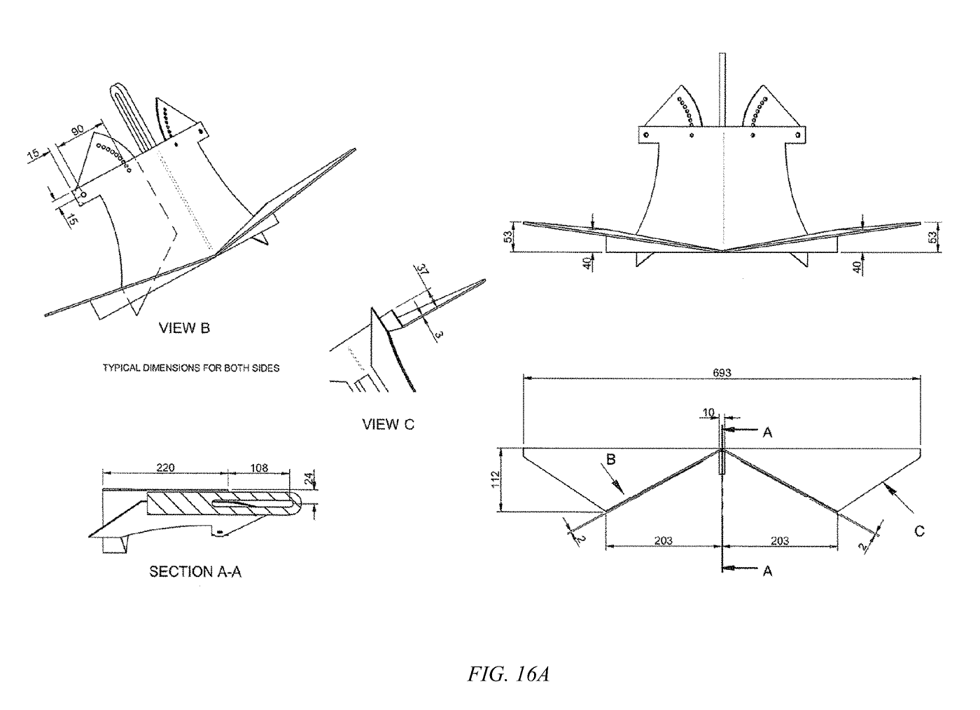

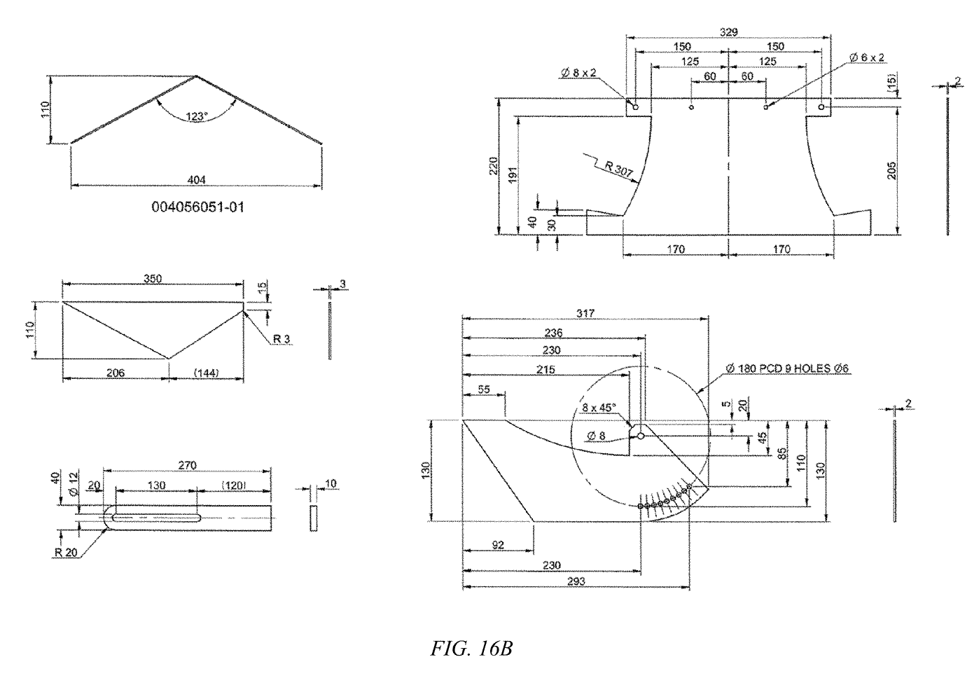

The lower edges 158 and 159 of the top surface are arcuate along their length, such that material falling therefrom under the impetus of gravity falls substantially onto an area which is a fixed distance from the rotation axis of the spreader disc. Additionally, the central diverter 150 comprises bracket 156 which when attached to a mounting arm allows for tilting of the central diverter. A pair of extendable wings 160 allows the upper surface of the central diverter to be extended if required. The preferred dimensions of the central diverter are shown in FIGS. 16A and 16B.

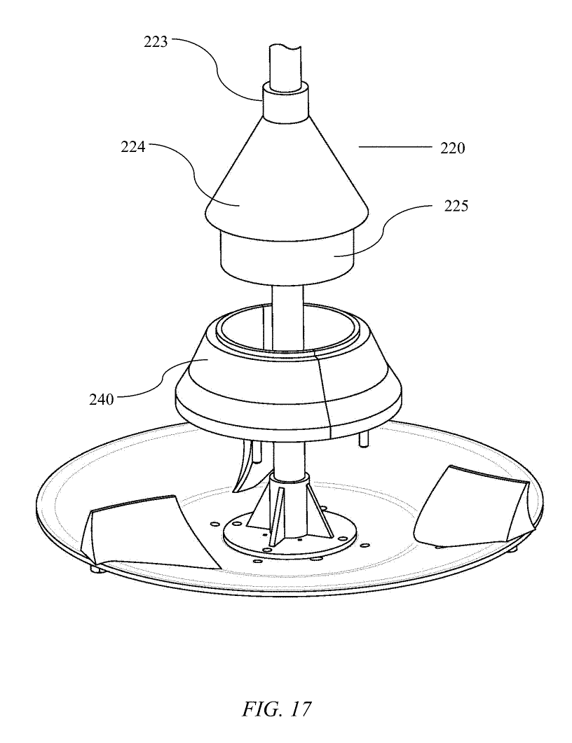

An alternative embodiment of the deflector assembly is shown in FIG. 17. A main deflector member 220 includes a cylindrical upper portion 223, a frusto-conical middle portion 224 and a cylindrical lower portion 225. The main deflector 220 is circular in cross-section and is concentric with the axis of rotation of the spreading disc. Lower portion 225 has a smaller radius than the radius of the middle portion to which it directly abuts, thereby forming an annular region of reduced dimension. A lower deflector sub-assembly 240 may be placed into the annular region to ensure that the outer surface of the deflector assembly has a suitable profile to achieve the desired distribution pattern.

Lower deflector sub-assembly may consist of a single annular member which fits over the main drive shaft of the spreading disc. Alternatively, to facilitate easy removal and replacement, the sub-assembly 240 may comprise a number of annular segments, which may slide into place around lower portion 225.

To secure the lower deflector sub-assembly in place, a number of cooperating ridges/grooves may be formed on lower portion 225 and lower deflector sub-assembly 240. A number of locating pins may extend from the sub-assembly so as to engage with corresponding holes in the spreading disc. FIG. 24 shows a lower deflector sub-assembly formed by two separate annular segments. Annular segment 241 is shown located in place with main deflector member 220. Annular segment 242 shows the arrangement of ridges 245 which cooperate with corresponding recesses or grooves in the middle and lower portions of main deflector member 220. Of course, other means of retaining the lower deflector sub-assembly in place may be used, such as, but not limited to, threaded screws, self locking bolts, cooperating bolts and nuts, latches, clasps, split pins, clips or the like.

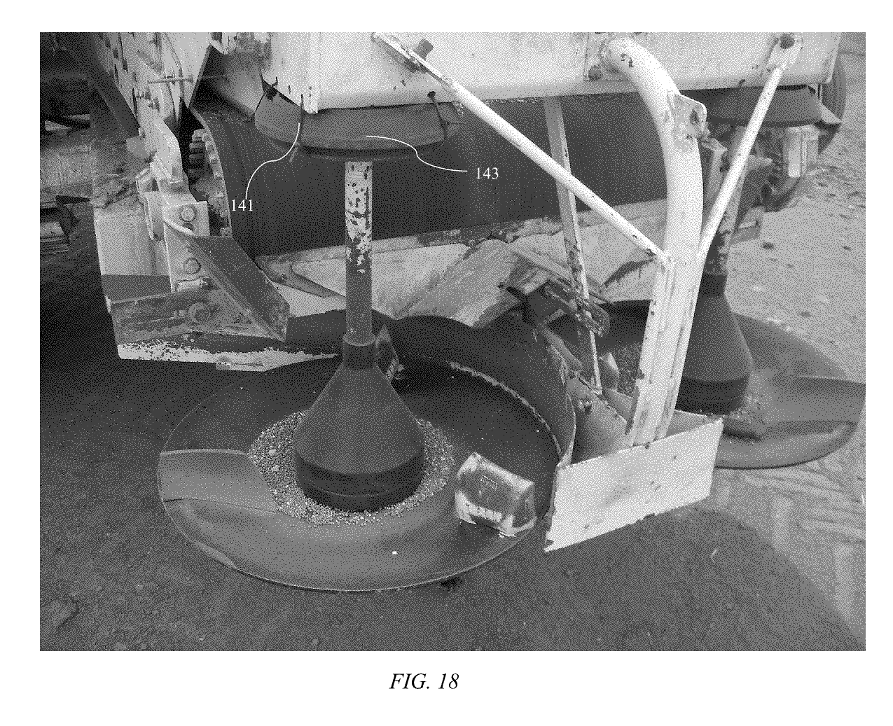

FIG. 18 is a view of a deflector assembly according to the first embodiment of the present invention comprising two deflector members. A second extension member 143 is shown securely attached to the top of the drive shaft. In both the concentric ring arrangement as shown in FIG. 1, and the nested arrangement as shown in FIG. 8, a deflector member may be removed from the array by sliding the deflector member to the top of the main drive shaft of the spreading disc, such that the deflector member does not impede the stream of particulate material being discharged onto the spreading disc. The deflector member may be removably secured at the top of the drive shaft by retaining means 141. In a preferred embodiment, retaining means 141 comprises a cable tie, though other conventional fastening techniques, such as, but not limited to, chains, threaded screws, self locking bolts, cooperating bolts and nuts, latches, clasps, split pins, clips or the like may be used.

Alternatively, the deflector member may be provided with an aperture or slot such that it may be removably engaged. For example, in the concentric ring configuration of the deflector array, the deflector member may be formed by two hingedly connected halves which allow the deflector member to wrap around the shaft or an inner deflector member. Similarly, in the nested configuration of the deflector array, the deflector member may be formed by two hingedly connected halves which allow the deflector member to wrap around the shaft or a lower deflector member.

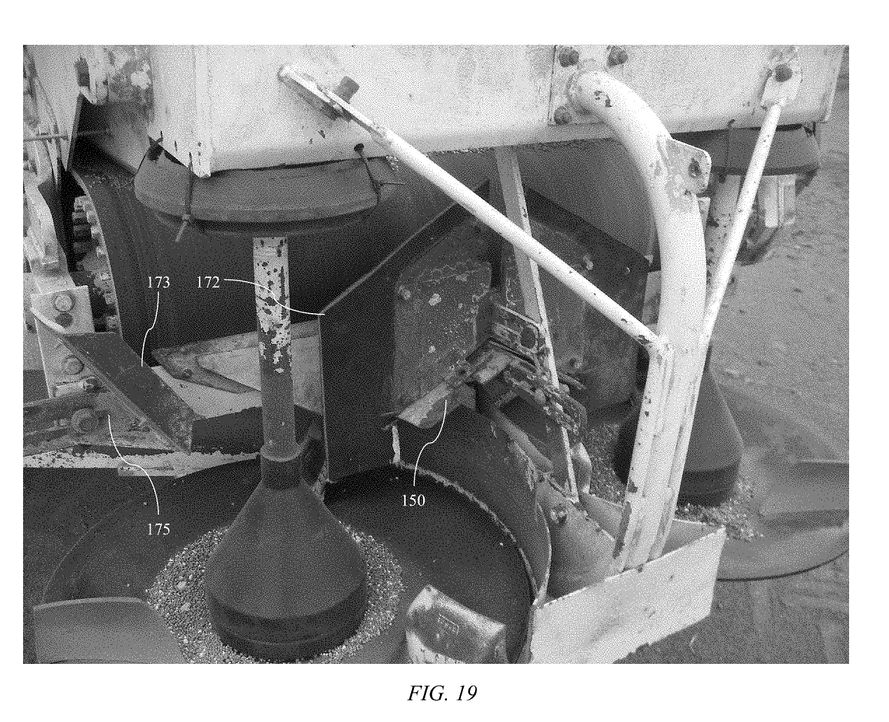

Referring to FIG. 19, the discharge deflector may also include a primary deflector 172 positionable adjacent the discharge outlet for directing the stream of particulate material downwards towards the central diverter and thus the spreading disc. Additionally, the discharge deflector includes a side deflector 173 positionable adjacent a side region of the discharge outlet for channeling the stream of particulate material towards the spreading disc.

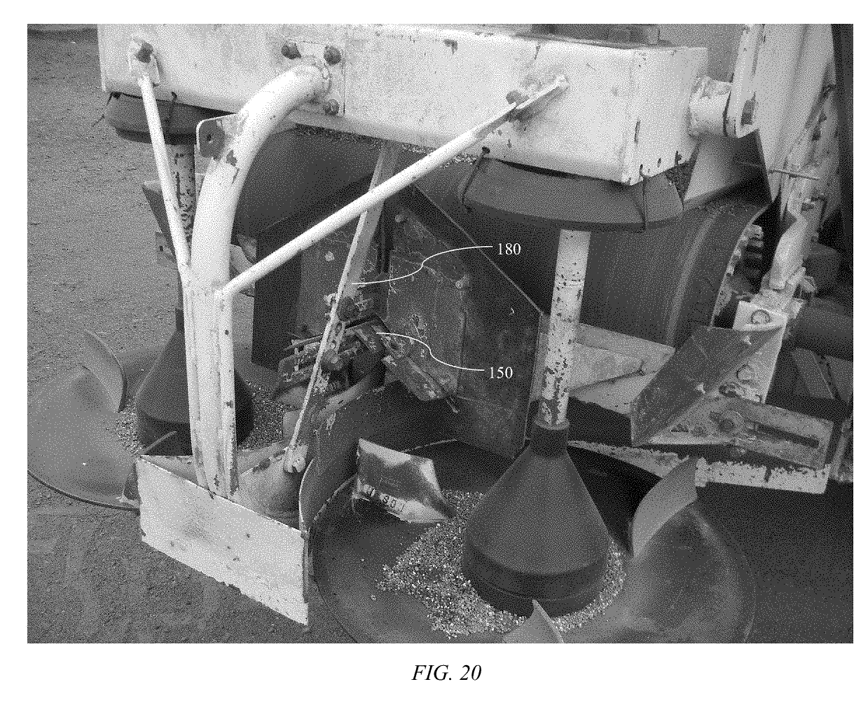

Primary deflector 172 is preferably disposed below the discharge outlet, and is adjustably mounted such that it is movable fore and aft in relation to the discharge outlet to facilitate distribution of the particulate material onto the central diverter 150. In an alternative embodiment, the primary deflector may also be adjusted vertically and tiltably in relation to the discharge outlet. Side deflector 173 is attached to bracket 175 which allows for horizontal and tiltable adjustment. The downward angle of side deflector 173 may be adjusted from 0° to 90°. A downward angle of about 30° to 45° to the stream of particulate material has been found to be suitable for most particulate materials. As seen in FIG. 20, the primary deflector may be attached to mounting arm 180 by a cooperating nut and bolt or other suitable attachment means above the central diverter 150.

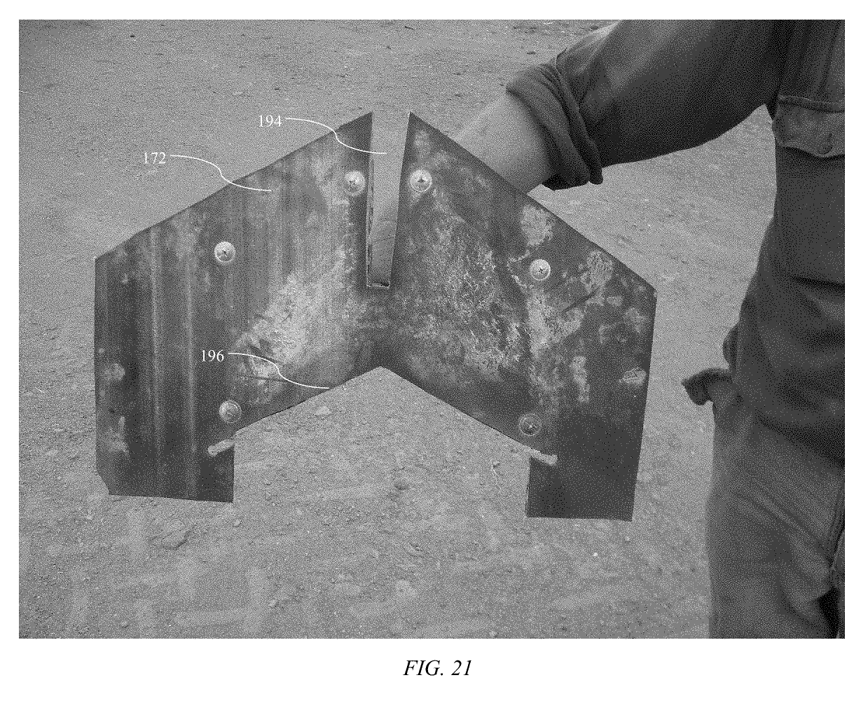

In a preferred embodiment, the primary deflector 172 has an inverted v-shape as shown in FIG. 21. A vertical aperture 194 allows the primary deflector to move fore and aft in relation to the mounting arm. The lower edge 196 of the primary deflector defines an aperture which allows the primary deflector to slidably engage with the central diverter. The primary deflector is preferably formed from polyurethane, though other materials such as metals and composites are suitable In an alternative embodiment, the central diverter may be integrally formed with the primary deflector.

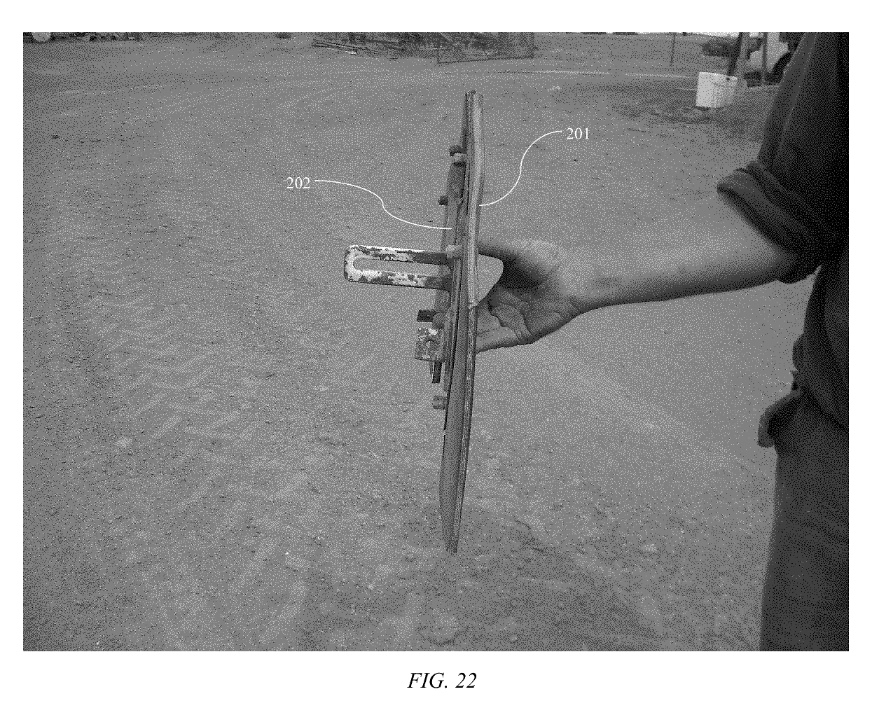

The primary deflector comprises a striking surface 201 and an attachment plate 202 as can be seen in FIG. 22. Striking surface 201 may be formed from any suitably rigid material such as plastics, rubber, composites or metal. In this example, the striking surface 201 is formed from rubber and is secured to the attachment plate 202 by a plurality of cooperating bolts and nuts. Depending upon the material or materials chosen for the striking surface, other conventional fastening techniques such as, but not limited to, threaded screws, latches, clasps, split pins, clips, rivet nuts, blind rivets, welding or any other comparable fastening means may be used.

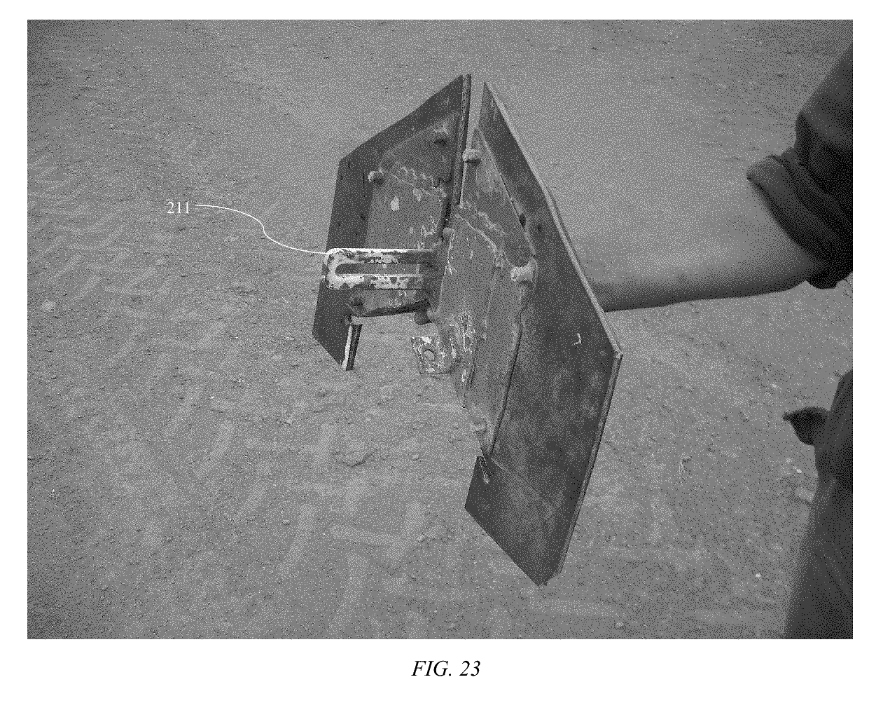

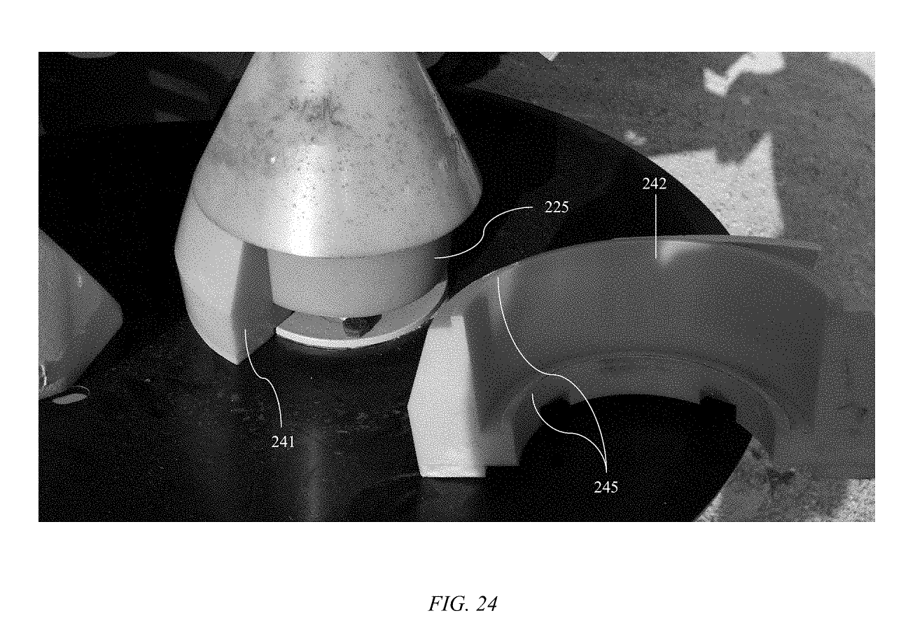

As shown in FIG. 23, the attachment plate of the primary deflector comprises bracket 211 which allows for fore and aft adjustment of the primary deflector. Here, it should be noted that the primary and side deflectors can be positioned and orientated differently for different applications.

The broadcast spreader of the invention provides a distribution system for particulate material having a smooth distribution pattern without significant peaks or skewing. It also provides adequate and convenient pattern adjustment for a wide range of material types. Moreover, the spreader rate and pattern mechanism are greatly simplified as compared to prior art systems.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgement or any form of suggestion that the prior art forms part of the common general knowledge in any jurisdiction.

Non-limiting examples of the invention include:

1. A deflector assembly for use with a spreading disc rotatable around a first axis, the deflector assembly comprising:

an array of deflector members concentrically disposed relative to the first axis;

wherein a stream of particulate material discharged onto the deflector assembly is deflected onto a portion of the spreading disc.

2. The deflector assembly of example 1, wherein the portion upon which the particulate material is deflected is altered by varying the number of deflector members in the array.

3. The deflector assembly of example 1, wherein the portion upon which the particulate material is deflected is altered by varying the shape of deflector members in the array.

4. The deflector assembly of example 1, wherein the portion upon which the particulate material is deflected is altered by rotating the deflector assembly.

5. The deflector assembly of example 1, wherein each deflector member has an upper surface which extends axially and radially.

6. The deflector assembly of example 1, wherein the array of deflector members is substantially frusto-conical in shape.

7. The deflector assembly of example 1, wherein the array of deflector members includes a main deflector member and at least one extension member.

8. The deflector assembly of example 7, wherein the or each at least one extension member is removable from the array of deflector members.

9. The deflector assembly of example 7, wherein the deflector members are made from a substantially homogeneous material.

10. A broadcast spreader including a deflector assembly for use with a spreading disc rotatable around a first axis, the deflector assembly comprising:

an array of deflector members concentrically disposed relative to the first axis;

wherein a stream of particulate material discharged onto the deflector assembly is deflected onto a portion of the spreading disc.

11. The broadcast spreader of example 10, wherein the portion of the spreading disc upon which the particulate material is deflected is altered by varying the shape of deflector members in the array.

12. The broadcast spreader of example 10, wherein the portion of the spreading disc upon which the particulate material is deflected is altered by rotating the deflector assembly.

13. The broadcast spreader of example 10, wherein each deflector member has an upper surface which extends axially and radially.

14. The broadcast spreader of example 10, wherein the array of deflector members is substantially frusto-conical in shape.

15. The broadcast spreader of example 10, wherein the array of deflector members includes a main deflector member and at least one extension member.

16. The broadcast spreader of example 15, wherein the deflector members are made from a substantially homogeneous material.

17. The broadcast spreader of example 1, further comprising a discharge deflector positioned adjacent a discharge outlet of the broadcast spreader.

18. The broadcast spreader of example 17, wherein the discharge deflector comprises:

a central diverter;

a primary deflector positionable adjacent the discharge outlet for directing a stream of particulate material downwards towards a spreading disc; and

a side deflector positionable adjacent a side region of the discharge outlet for channeling the stream of particulate material towards the spreading disc.

19. The broadcast spreader of example 18, wherein the primary deflector is disposed below the discharge outlet.

20. The broadcast spreader of example 19, wherein the primary deflector is movable in relation to the discharge outlet.

Although the invention has been disclosed in its preferred forms, it is to be understood that the above embodiments and examples have been provided only by way of exemplification of this invention, and that further modifications and improvements thereto, as would be apparent to persons skilled in the relevant art, are deemed to fall within the broad scope and ambit of the current invention described and claimed herein.

1. An apparatus comprising:
a spreading disc rotatable around a first axis, the spreading disc comprising a curved surface; and
a deflector assembly for use with the spreading disc, the deflector assembly comprising:
an array of stackable deflector members concentrically disposed relative to the first axis;
wherein a stream of particulate material which is discharged onto the deflector assembly is deflected onto a portion of the spreading disc.

2. The apparatus of claim 1, wherein the portion of the spreading disc upon which the particulate material is deflected is altered by varying the number of deflector members in the array of stackable deflector members.

3. The apparatus of claim 1, wherein each deflector member in the array of stackable deflector members has an upper surface which extends axially and radially.

4. The apparatus of claim 1, wherein the array of stackable deflector members is substantially frusto-conical in shape.

5. The apparatus of claim 1, wherein each deflector member in the array of stackable deflector members has a bottom surface which substantially abuts an upper surface of the spreading disc.

6. The apparatus of claim 1, wherein the array of stackable deflector members includes a main deflector member and at least one extension member.

7. The apparatus of claim 6, wherein each of the at least one extension members is removable from the array of stackable deflector members.

8. The apparatus of claim 6, wherein an upper surface of the main deflector member abuts a lower surface of an extension member which is stacked above the main deflector member.

9. The apparatus of claim 1, wherein the deflector members in the array of stackable deflector members are made from a substantially homogeneous material.

10. The apparatus of claim 9, wherein the deflector members are made of metal.

11. The apparatus of claim 9, wherein the deflector members are made of rubber.

12. The apparatus of claim 9, wherein the deflector members are made of plastic.
